(19) United States
(12) Patent Application Publication
(10) Pub. No.: US 2008/0246665 A1
(43) Pub. Date: Oct. 9, 2008

(54) Antenna device

(75) Inventors: Shigemi Kurashima, Shinagawa (JP); Masahiro Yanagi, Shinagawa (JP); Takashi Yuba, Shinagawa (JP); Satoshi Sakurai, Shinagawa (JP); Takashi Arita, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/907,823

(22) Filed: Oct. 17, 2007

(30) Foreign Application Priority Data
Apr. 9, 2007 (JP) 2007-101624

(51) Int. Cl. H01Q 9/04

(52) U.S. Cl. 343/700 MS

(57) ABSTRACT

An antenna device is provided that includes a ground and an element including a first element component part and a second element component part. The first element component part has a first end facing a side of the ground and serving as a connection point, and extends from the first end in a direction, away from the ground. The second element component part is connected to a second end of the first element component part so as to extend substantially parallel to the side of the ground part.

### BACKGROUND OF THE INVENTION

1. Field of the Invention

The present invention generally relates to antenna devices, and more particularly to an antenna device including a ground and an element.

2. Description of the Related Art

In these years, it has been desired to eliminate cables between a computer and peripheral devices as the computer and its peripheral devices develop.

In this respect, UWB (Ultra Wideband), which enables communications at high data transfer rates, has attracted attention as a radio communications technology for performing communications between the computer and its peripheral devices. Since 2002, USB has been approved for use in a frequency band of 3.1 to 10.6 GHz by the U.S. FCC (Federal Communications Commission).

UWB is a communication method that communicates pulse signals in the ultra wideband. Accordingly, antennas used for UWB are required to have a configuration that enables transmission and reception in the ultra wideband.

As an antenna for use in at least the FCC-approved 3.1-10.6 GHz band, an antenna having a conic or teardrop-shaped feeding body placed on a flat ground plate has been proposed (Taniguchi, T. and T. Kobayashi [Tokyo Denki University]; “An Omnidirectional and Low-VSWR Antenna for the FCC-approved UWB Frequency Band,” 2003 General Conference of Institute of Electronics, Information, and Communications Engineers, B-1-133, presented in the classroom B201 on March 22).

However, since the conventional antenna device having a conic or teardrop-shaped feeding body placed on a flat ground plate is large in size, there has been demand for reduction in the size and thickness of the antenna device.

On the other hand, regarding loop antennas used for communications in low-frequency bands, an antenna device having an element formed with a conductive pattern on a flexible substrate has been proposed. (See, for example, Japanese Laid-Open Patent Application No. 2000-196327.)

However, UWB antenna devices are large in size, so that it is difficult to place them in narrow spaces.

### SUMMARY OF THE INVENTION

According to one embodiment of the present invention, there is provided a small-size antenna device that enables wideband communications.

According to one embodiment of the present invention, there is provided an antenna device including a ground and an element including a first element component part and a second element component part, wherein the first element component part has a first end thereof facing a side of the ground and serving as a connection point, and extends from the first end in a direction away from the ground, and the second element component part is connected to a second end of the first element component part so as to extend substantially parallel to the side of the ground part.

According to the above-described configuration, it is possible to provide a small-size antenna device that enables wideband communications.

### BRIEF DESCRIPTION OF THE DRAWINGS

Other objects, features and advantages of the present invention will become more apparent from the following detailed description when read in conjunction with the accompanying drawings, in which:

FIG. 1 is a perspective view of an antenna device according to a first embodiment of the present invention;

FIG. 2 is an exploded perspective view of the antenna device according to the first embodiment of the present invention;

FIGS. 3A and 3B are a plan view and a side view, respectively, of the antenna device according to the first embodiment of the present invention;

FIGS. 4A, 4B, and 4C are graphs showing various characteristics obtained with the antenna device of the first embodiment of the present invention;

FIG. 5 is a perspective view of an antenna device according to a second embodiment of the present invention;

FIG. 6 is a plan view of the antenna device according to the second embodiment of the present invention;

FIG. 7 is a graph showing a frequency-VSWR characteristic according to the second embodiment of the present invention;

FIG. 8 is a perspective view of an antenna device according to a third embodiment of the present invention;

FIG. 9 is an exploded perspective view of the antenna device according to the third embodiment of the present invention;

FIGS. 10A and 10B are a plan view and a side view, respectively, of the antenna device according to the third embodiment of the present invention;

FIGS. 11A, 11B, and 11C are graphs showing various characteristics obtained with the antenna device of the third embodiment of the present invention;

FIG. 12 is a perspective view of an antenna device according to a fourth embodiment of the present invention;

FIG. 13 is a plan view of the antenna device according to the fourth embodiment of the present invention;

FIG. 14 is a graph showing a frequency-VSWR characteristic according to the fourth embodiment of the present invention; and

FIG. 15 is a perspective view of an application of an embodiment of the present invention.

### DETAILED DESCRIPTION OF THE PREFERRED EMBODIMENTS

A description is given below, with reference to the accompanying drawings, of embodiments of the present invention.

### First Embodiment

FIG. 1 is a perspective view of an antenna device 100 according to a first embodiment of the present invention.

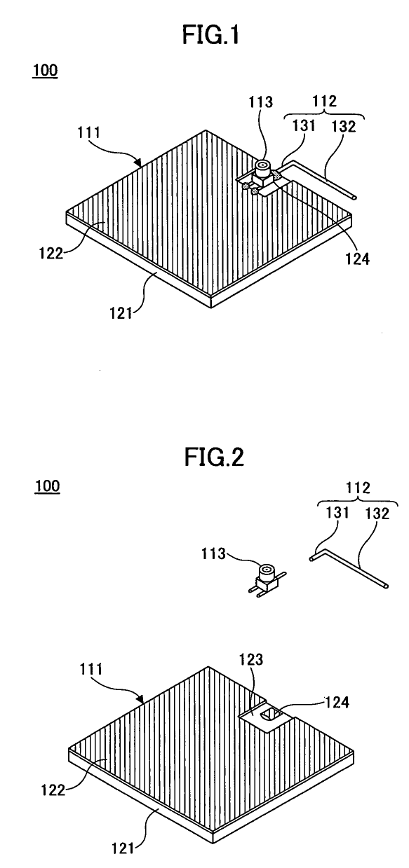

FIG. 2 is an exploded perspective view of the antenna device 100 according to the first embodiment of the present invention.

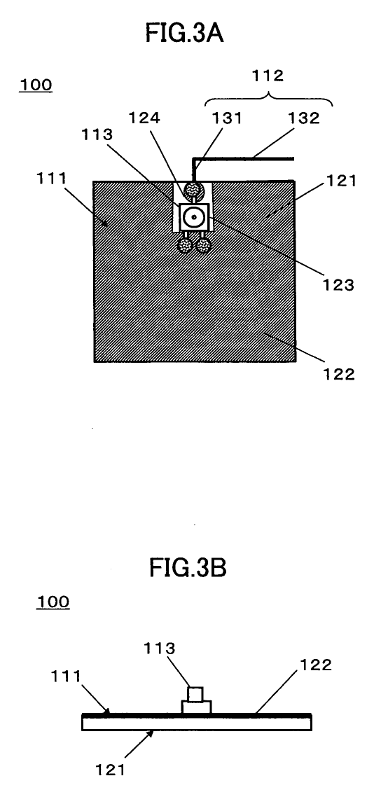

FIGS. 3A and 3B are a plan view and a side view, respectively, of the antenna device 100 according to the first embodiment of the present invention.

The antenna device 100 of this embodiment is capable of transmitting and receiving radio waves over a wide band of frequencies between approximately 4.2 and 4.8 GHz with a VSWR (Voltage Standing Wave Ratio) of 2.5 or less. The antenna device 100 includes a ground part 111, an element part 112, and a connector 113.

The ground part 111 includes a conductive pattern 122 formed on a printed wiring board 121.

The printed wiring board 121 is formed to have a quadrilateral shape approximately 30 mm square. The conductive pattern 122 is formed substantially entirely over one side of the printed wiring board 121. The printed wiring board 121 is formed of a dielectric such as FR4. The printed wiring board 121 may be a flexible one such as a flexible printed circuit.

A concave part 123 is formed in the center of one side of the conductive pattern 122 on the periphery of the printed wiring board 121. The concave part 123 is a concave cutout formed in the conductive pattern 122 toward the center of the printed wiring board 121. A connection pad 124 is formed on the printed wiring board 121 in the concave part 123.

The element part 112 and the connector 113 are soldered to the connection pad 124.

The element part 112 is formed by bending a conductive linear material such as a wire so as to have a first element component part 131 and a second element component part 132.

The first element component part 131 has a linear shape, and has one end thereof soldered to the connection pad 124 formed on the printed wiring board 121 in the concave part 123. The first element component part 131 extends (projects) approximately 4 mm to 5 mm relative to the corresponding side edge of the ground part 111 formed on the printed wiring board 121 in a direction perpendicular to the side edge.

The second element component part 132 extends approximately 14 mm from the other end of the first element component part 131 in a direction substantially perpendicular thereto so as to be parallel to the side edge of the ground part 111. The second element component part 132 has an open end on the side opposite to the first element component part 131.

The connector 113 is formed of a coaxial socket connector. The connector 113 has its signal line connected to the connection pad 124 and its ground lines connected to the conductive pattern 122 in the concave part 123.

A plug connector connected to the end of a coaxial cable is to be connected to the connector 113.

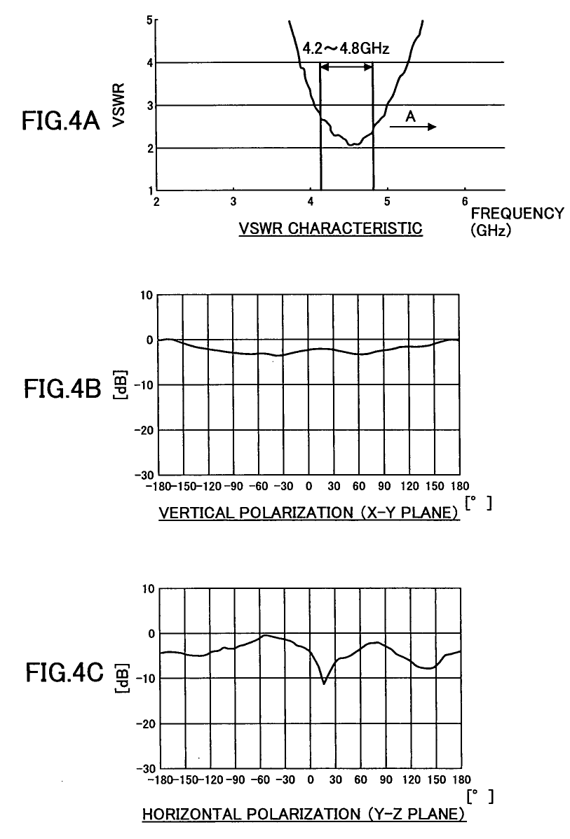

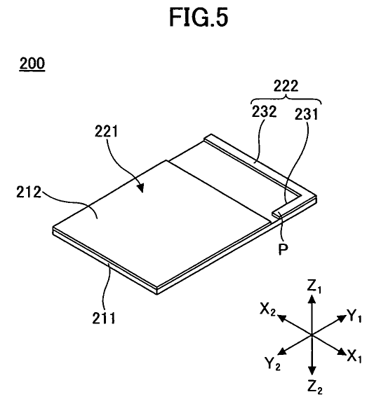

FIGS. 4A, 4B, and 4C are graphs showing various characteristics obtained with the antenna device 100 of the first embodiment of the present invention.

FIG. 4A shows the VSWR characteristic. FIG. 4B shows the angle-gain characteristic of vertical polarization (X-Y plane). FIG. 4C shows the angle-gain characteristic of horizontal polarization (Y-Z plane).

FIG. 4A shows that the antenna device 100 of this embodiment can reduce the VSWR to approximately 2.5 or less in the frequency range of 4.2 to 4.8 GHz. Further, FIGS. 4B and 4C show that sufficient gain can be obtained for both vertical and horizontal polarizations with the antenna device 100 of this embodiment.

In the first embodiment, the element part 112 is formed of a conductive linear material. Alternatively, the element part 112 may be formed of a conductive pattern on the printed wiring board 121.

By reducing the length of the second element component part 132, the VSWR characteristic can be shifted to the high frequency side or in the direction indicated by arrow A in FIG. 4A.

According to this embodiment, the element part 112 projects no more than approximately 4 mm to 5 mm relative to the ground part 111. Accordingly, it is possible to provide a small-size antenna device, while it is also possible to perform communications in a 4.2-4.8 GHz wide band.

Moreover, further reduction in size is possible by using the enclosure of an apparatus on which the antenna device 100 is mounted, such as the bezel of an LCD of a notebook computer, as the ground part 111.

### Second Embodiment

FIG. 5 is a perspective view of an antenna device 200 according to a second embodiment of the present invention.

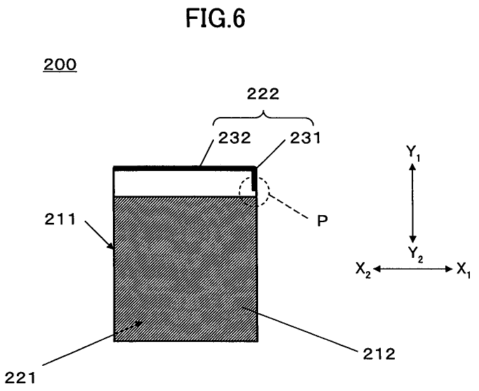

FIG. 6 is a plan view of the antenna device 200 according to the second embodiment of the present invention.

The antenna device 200 of this embodiment includes a ground part 221 and an element part 222 each formed of a conductive pattern 212 on a printed wiring board 211 having a rectangular shape of approximately 35 mm×30 mm.

The conductive pattern 212 forming the ground part 221 is formed over approximately 30 mm in the longitudinal directions of the printed wiring board 211 or in the Y1-Y2 directions. The element part 222 is formed of the conductive pattern 212 of approximately 0.5 mm in line width along the peripheral edge of the printed wiring board 211.

The element part 222 includes a first element component part 231 and a second element component part 232. One end of the first element component part 231 serves as a feeding point P. The first element component part 231 extends approximately 5 mm from the X₁-Y₁ corner (upper right corner in FIG. 6) of the printed wiring board 211 in the Y₂ direction along its X₁ side so that the feeding point P faces the ground part 221. The first element component part 231 and the ground part 221 are not connected.

The second element component part 232 extends from the other end of the first element component part 231 in a direction perpendicular thereto or in the width (X₁-X₂) directions of the printed wiring board 211. That is, the second element component part 232 is formed parallel to the Y₁ side of the ground part 221. The X₂ end of the second element component part 232 is open. That is, the element part 222 is formed of the conductive pattern 212 of approximately 0.5 mm in line width along the peripheral edge of the printed wiring board 211.

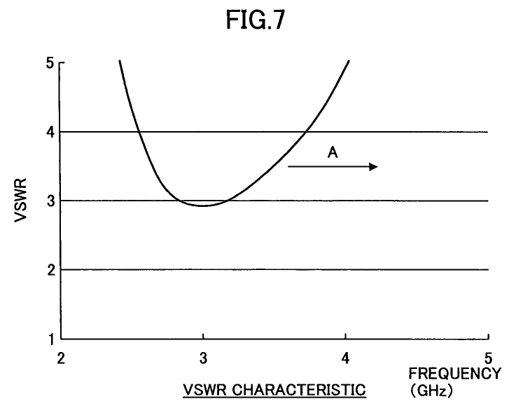

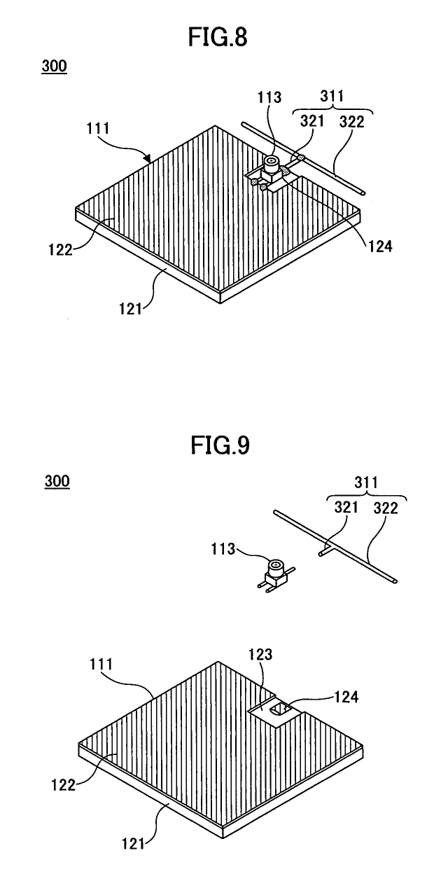

FIG. 7 is a graph showing a frequency-VSWR characteristic according to the second embodiment of the present invention.

FIG. 7 shows that the antenna device 200 of this embodiment can reduce the VSWR to 3 or less. Further, by reducing the length of the second element component part 232, the VSWR characteristic can be shifted to the high frequency side or in the direction indicated by arrow A in FIG. 7.

### Third Embodiment

FIG. 8 is a perspective view of an antenna device 300 according to a third embodiment of the present invention.

FIG. 9 is an exploded perspective view of the antenna device 300 according to the third embodiment of the present invention.

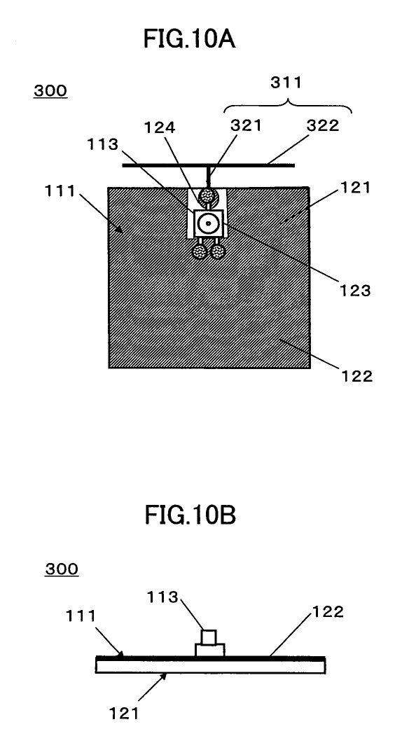

FIGS. 10A and 10B are a plan view and a side view, respectively, of the antenna device 300 according to the third embodiment of the present invention.

In FIGS. 8, 9, 10A, and 10B, the same elements as those of FIGS. 1, 2, 3A, and 3B are referred to by the same numerals, and a description thereof is omitted.

The antenna device 300 of this embodiment is capable of transmitting and receiving radio waves over a wide band of frequencies between approximately 4.2 and 4.8 GHz with a VSWR of 2.5 or less. The antenna device 300 of this embodiment is different from the antenna device 100 of the first embodiment in the configuration of the element part.

The antenna device 300 includes an element part 311. The element part 311 includes a first element component part 321 and a second element component part 322. The first element component part 321 and the second element component part 322 are formed of different linear materials (for example, wires).

The first element component part 321 has a linear shape, and has one end thereof soldered to the connection pad 124 formed on the printed wiring board 121 in the concave part 123. The first element component part 321 extends (projects) approximately 4 mm relative to the corresponding side edge of the ground part 111 formed on the printed wiring board 121.

The second element component part 322 is formed of a linear material of approximately 22 mm in length. The center part of the second element component part 322 is soldered to the other end of the first element component part 321 so that the second element component part 322 is fixed to be substantially parallel to the side edge of the ground part 111. Both ends of the second element component part 322 are open.

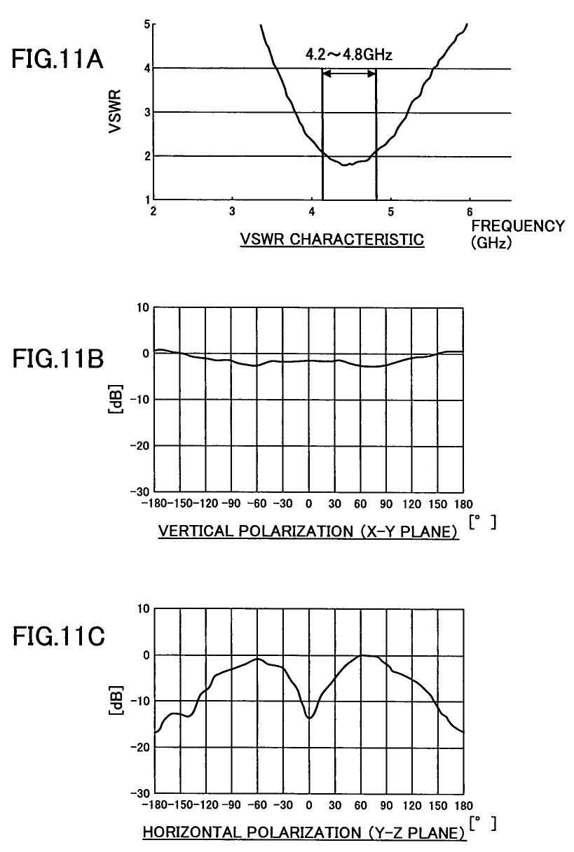

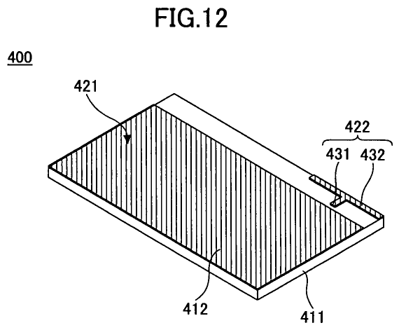

FIGS. 11A, 11B, and 11C are graphs showing various characteristics obtained with the antenna device 300 of the third embodiment of the present invention.

FIG. 11A shows the VSWR characteristic. FIG. 11B shows the angle-gain characteristic of vertical polarization (X-Y plane). FIG. 11C shows the angle-gain characteristic of horizontal polarization (Y-Z plane).

FIG. 11A shows that the antenna device 300 of this embodiment can reduce the VSWR to approximately 2.5 or less in the frequency range of 4.2 to 4.8 GHz. Further, FIGS. 11B and 11C show that sufficient gain can be obtained for both vertical and horizontal polarizations with the antenna device 300 of this embodiment.

In the third embodiment, the element part 311 is formed of conductive linear materials. Alternatively, the element part 311 may be formed of a conductive pattern on the printed wiring board 121.

### Fourth Embodiment

FIG. 12 is a perspective view of an antenna device 400 according to a fourth embodiment of the present invention.

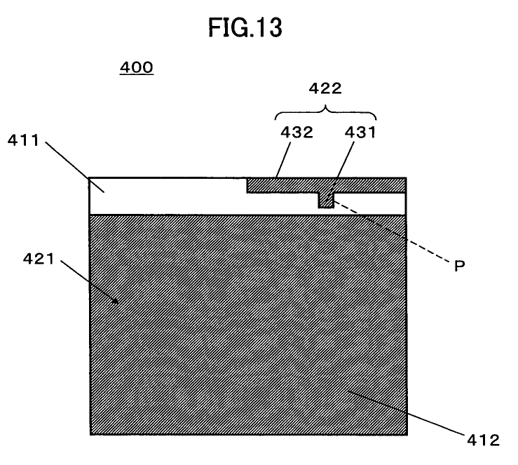

FIG. 13 is a plan view of the antenna device 400 according to the fourth embodiment of the present invention.

The antenna device 400 of this embodiment includes a ground part 421 and an element part 422 each formed of a conductive pattern 412 on a printed wiring board 411.

The ground part 421 is formed of the conductive pattern 412 having a rectangular shape of approximately 200 mm×100 mm.

The element part 422 is formed at the upper right corner (FIG. 13) of the printed wiring board 411 so as to have a T-letter shape.

The element part 422 includes a first element component part 431 and a second element component part 432. The first element component part 431 extends approximately 5 mm from the second element component part 432 toward the ground part 421 so that the end of the first element component part 431 faces the corresponding side edge of the ground part 421.

The second element component part 432 is formed of a linear pattern of 0.5 mm to 3 mm in line width, and extends approximately 25 mm to 30 mm so as to be parallel to the side edge of the ground part 421.

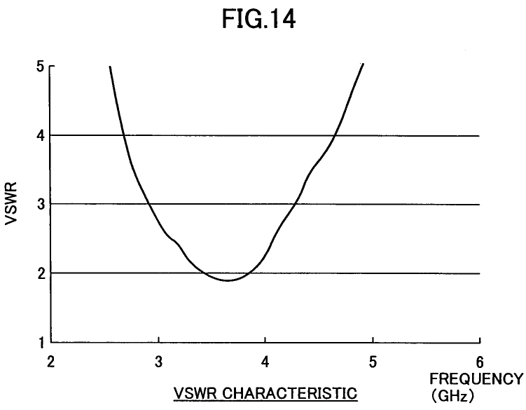

FIG. 14 is a graph showing a frequency-VSWR characteristic according to the fourth embodiment of the present invention.

FIG. 14 shows that the antenna device 400 of this embodiment can reduce the VSWR to 3 or less over a wide band of frequencies between 2.9 GHz and 4.3 GHz.

[Application]

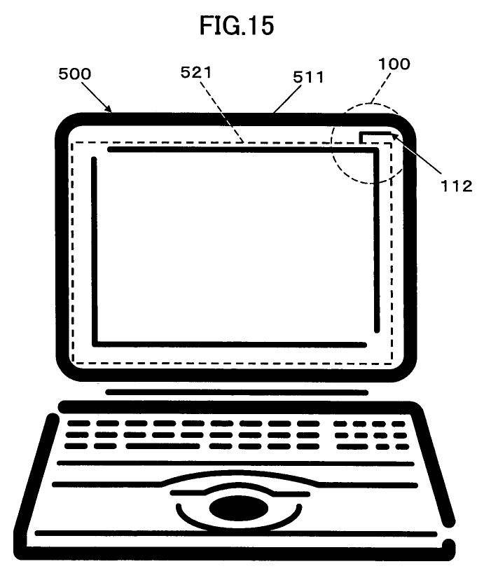

FIG. 15 is a perspective view of an application of an embodiment of the present invention.

According to this application, a bezel 521 of an LCD 511 of a notebook computer 500 serves as the ground part 111 (FIGS. 1 through 3B), and the element part 112 (FIGS. 1 through 3B) extends from the bezel 521. Thereby, the antenna device 100 of the first embodiment can be mounted on the notebook computer 500.

Thus, according to one embodiment of the present invention, there is provided an antenna device including a ground and an element including a first element component part and a second element component part, wherein the first element component part has a first end thereof facing a side of the ground and serving as a connection point, and extends from the first end in a direction away from the ground, and the second element component part is connected to a second end of the first element component part so as to extend substantially parallel to the side of the ground part.

According to the above-described configuration, it is possible to provide a small-size antenna device that enables wideband communications.

The present invention is not limited to the specifically disclosed embodiments, and variations and modifications may be made without departing from the scope of the present invention.

The present application is based on Japanese Priority Patent Application No. 2007-101624, filed on Apr. 9, 2007, the entire contents of which are hereby incorporated by reference.

What is claimed is:

1. An antenna device, comprising:
a ground; and
an element including a first element component part and a second element component part,
wherein the first element component part has a first end thereof facing a side of the ground and serving as a connection point, and extends from the first end in a direction away from the ground, and
the second element component part is connected to a second end of the first element component part so as to extend substantially parallel to the side of the ground part.

2. The antenna device as claimed in claim 1, wherein the second element component part has first and second open ends, and
the second end of the first element component part is connected to a part of the second element component part between the first and second ends thereof.

3. The antenna device as claimed in claim 1, wherein the second element component part has first and second ends, the first end being connected to the first element component part and the second end being open.

4. The antenna device as claimed in claim 1, wherein the ground is provided along an electric conductor of a mounting portion on which the antenna device is mounted, and
the element extends from the electric conductor.

5. The antenna device as claimed in claim 4, wherein the mounting portion is a bezel of a display.

6. The antenna device as claimed in claim 1, wherein the ground is formed of a conductive pattern on a dielectric substrate.

7. The antenna device as claimed in claim 6, wherein the element is formed of a conductive linear material.

8. The antenna device as claimed in claim 6, wherein the element is formed of a conductive pattern on the dielectric substrate on which the ground is formed.

9. The antenna device as claimed in claim 6, wherein the dielectric substrate has flexibility.

10. The antenna device as claimed in claim 1, wherein the antenna device is used for radio Ultra Wideband communications.
